(19) United States
(12) Patent Application Publication
(10) Pub. No.: US 2006/0041385 A1
(43) Pub. Date: Feb. 23, 2006

(54) Method of quantitating proteins and genes in cells using a combination of immunohistochemistry and in situ hybridization

(76) Inventors: Kenneth D. Bauer, San Clemente, CA (US); Keith Gottlieb, Newport Beach, CA (US); Scott Webster, Mission Viejo, CA (US)

Correspondence Address: FISH & RICHARDSON, PC, P.O. BOX 1022, MINNEAPOLIS, MN, 55440-1022, US

(21) Appl. No.: 10/922,121

(22) Filed: Aug. 18, 2004

(51) Int. Cl. G06F 19/00

(52) U.S. Cl. 702/19

(57) ABSTRACT

The disclosure provides a system for and method of accurately determining the status of a protein target and a nucleic acid target in a biological sample (e.g., a tissue or cell sample). Provided are methods of quantitating a protein target and a nucleic acid target in a tissue or cell sample using image analysis to correlate the optical density of a chromogenic stain to the concentration of a target molecule in a biological sample. The use CISH in combination with IHC to accurately determine the status of two independent target molecules is provided. A computer-aided image analysis system is used to process and analyze optical images of a chromagen-stained tissue or cell sample and to determine the optical density of the stained tissue or cell sample.

### TECHNICAL FIELD

This disclosure relates to the detection of target molecules in a biological sample using chromogenic in situ hybridization (CISH) and immunohistochemistry (IHC) in combination, and more particularly the disclosure provides a system for and method of accurately quantitating markers in a biological sample (e.g., a tissue or cell sample) using image analysis.

### BACKGROUND

In the field of anatomic pathology, a piece of human tissue is typically inspected and analyzed microscopically by staining the tissue with a substance that reveals the presence of material of diagnostic significance. Material of diagnostic significance includes cellular proteins that are aberrantly expressed and nucleic acid abnormalities (e.g., DNA) in diseased tissues.

Aberrant protein expression (e.g., overexpression) and/or nucleic acid abnormalities (e.g., gene amplification) have been identified for a number of pathological conditions. For example, HER2/neu protein overexpression and/or HER2/neu (erbB-2) gene amplification have been identified as markers for invasive breast cancer. HER2/neu is a growth factor receptor that, when overexpressed, leads to aggressive cell growth. Determination of HER2/neu status is important for diagnosing and determining the prognosis of a subject diagnosed with invasive breast cancer. Additionally, the overexpression of HER2/neu is useful for selecting subjects with HER2/neu overexpression for therapy with antibodies against HER2/neu protein (i.e., Herceptin therapy). Herceptin therapy is only effective in patients whose tumors show HER2/neu gene amplification and/or HER2/neu protein overexpression. Therapeutic availability increases the need for a standard methodology for accurately and reliably assessing the status of HER2/neu in tumor tissues. Current diagnostic tests typically examine HER2/neu protein levels in breast tissue samples. In marginal cases, it is often difficult to make an accurate diagnosis based on a single test for HER2/neu status. A second, independent test such as a test for HER2/neu gene amplification in combination with a test for HER2/neu protein expression is highly desirable. Thus, there exists a need for method of accurately determining the status of two or more diagnostic target molecules simultaneously in a biological sample (e.g., a tissue sample).

### SUMMARY

The invention provides a method comprising measuring a plurality of colors in a biological sample on a slide, wherein at least a first color is associated with an IHC stained polypeptide and a second color is associated with a CISH stained polynucleotide; determining an amount of IHC stained polypeptide in the sample and an amount of CISH stained polynucleotide by comparing the first color to a first standard and the second color to a second standard.

The invention also provides a computer program on computer readable medium comprising instructions to cause a computer to measure a plurality of colors in a biological sample on a slide, wherein at least a first color is associated with an IHC stained polypeptide and a second color is associated with a CISH stained polynucleotide; determine an amount of IHC stained polypeptide in the sample and an amount of CISH stained polynucleotide by comparing the first color to a first standard and the second color to a second standard; and outputting an indication of the amounts of polypeptide and polynucleotide.

The invention further provides a machine vision system for automated analysis of a biological sample on a slide comprising a monitor in operable communication with a computer and an input device in communication with the computer; an optical system in operable communication with the computer, the optical system comprising: a movable stage, an automated loading and unloading member for slide handling, an identification member, an optical sensing array in optical communication with the stage and in electrical communication with the processor to acquire an image at a location on a slide; a storage member for storing the location of a candidate object or area of interest; and a storage device for storing each image; the computer having a system processor and a computer program on computer readable medium, the computer program comprising an image algorithm comprising instructions to cause the computer to measure a color channel value in a plurality of pixels from a plurality of control samples comprising a single color of interest; define a vector for each of the plurality of control samples, wherein each vector comprises an average of each color channel value present in the control; define a matrix comprising each of the averages for each of the color channels; define a conversion matrix comprising the inverse of the matrix based upon the control measurements; measure color channel values in an image of an experimental sample comprising a plurality of colors of interest, each of the pixels comprising a plurality of color channels; determine an amount of an IHC stained polypeptide in the sample and an amount of a CISH stained polynucleotide by calculating the amount of a color in the experimental sample by converting the channel values in the experimental sample using the conversion matrix; and outputting an indication of the amounts of polypeptide and polynucleotide.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an exemplary apparatus for automated cell analysis embodying the disclosure.

FIG. 2 is a block diagram of the apparatus shown in FIG. 1.

FIG. 3 is a block diagram of the system processor of FIG. 2.

FIG. 4 is a plan view of the apparatus of FIG. 1 having the housing removed.

FIG. 5 is a side view of a microscope subsystem of the apparatus of FIG. 1.

FIG. 6 illustrates a conventional microscope slide for use within the microscope imaging system of the present invention.

FIG. 7 illustrates a flow diagram of a method of establishing a calibration curve.

FIG. 8 illustrates a flow diagram of a method of accurately determining the status of one or more target molecules in a biological sample.

FIG. 9 shows a process for identifying the amount of a particular color or stain in a sample.

Like reference symbols in the various drawings indicate like elements.

### DETAILED DESCRIPTION

The systems and techniques described herein relate to image acquisition and analysis of biological samples on a microscope slide. For example, the systems and techniques provide for efficient and accurate imaging and analysis of materials on a slide using one or more (e.g., a plurality) of stains or reagents for identifying markers, cells, or areas of interest in a biological sample.

Current techniques used to detect protein expression and gene amplification include immunohistochemistry (IHC) and in situ hybridization (ISH), respectively. IHC staining uses an antibody specific to a protein of interest (e.g., HER2/neu) that is applied to a thin section of tissue sample. The antibody binding reaction is typically detected using an enzymatic system, such as alkaline phosphatase, glucose oxidase, or horseradish peroxidase, that is chemically conjugated to the antibody and is used to convert a soluble colorless substrate (i.e., a chromagen substrate) to a colored insoluble precipitate. The colored precipitate is a light-absorbing dye that is visualized directly through bright field microscopy. Alternatively, a dye (e.g., a chromagen) is directly conjugated to the antibody. A technician or pathologist visually inspects the tissue sample, counting the proportion of cells that are stained and scoring the intensity of the stain. The color intensity is related to the amount of the target molecule present. For example, a diagnostically significant event is often visualized as an elevation of the level of the protein that translates to a darker shade of the stain color.

In situ hybridization is used to determine the presence or absence of a polynucleotide (e.g., DNA or RNA) in a sample. In situ hybridization can detect the amplification of a gene, the rearrangement of chromosomes (translocation), or the change in the number of chromosomes. Conventional ISH approaches use fluorescently tagged nucleic acid probes (e.g., DNA probes) to detect a gene of interest (e.g., erbB-2); these approaches are referred to as fluorescent in situ hybridization (FISH). Fluorescent probes provide high sensitivity with low endogenous background, high resolution, multiple-target analysis with different fluorochromes, and the possibility to quantitate the signal. However, there are a number of limitations associated with the use of fluorescent probes. First, the signals generated by fluorescent probes typically fade over time. Second, exposure to light and auto-fluorescence of the tissue sample may mask the presence of a target signal. Additionally, the cost and availability of fluorescent microscopy equipment and trained personnel is greater than for conventional bright field microscopy.

An alternative to FISH is chromogenic in situ hybridization (CISH). CISH uses the enzymatic systems and chromogen substrates (i.e., light-absorbing dyes) typically used in IHC. This system permits the localization of hybridization sites through enzyme precipitation reactions. CISH provides the advantages of a stable color reaction, long-term storage of tissue preparations, and the use of standard bright field microscopy in a setting in which routine analysis is performed.

Although the disclosure discusses CISH methods, kits, and compositions for detecting HER2 gene status, one of skill in the art will recognize that the methods, kits and compositions are applicable to a wide variety of diseases and disorders having both a protein expression assay technique and a nucleic acid assay technique. The disclosure provides a method of screening a biological sample for the presence or absence of gene amplification. In one embodiment, the presence or absence of gene amplification is assessed by manually counting the number of chromogenic precipitate “dots” formed or determining the size of chromogenic precipitate clusters using bright field microscopy. However, it is difficult to manually count chromogenic precipitate dots using bright field microscopy and is often subject to counting errors. Further, determining the size of chromogenic precipitate clusters is subject to measurement errors and may lead to under or over representation of the number of polynucleotide copies. Thus, there exists a need for a system and method for accurately and reliably detecting the expression of a nucleic acid target molecule (e.g., gene copy number) in a biological sample (e.g., a tissue sample).

An alternative approach for determining the amount of a chromogenic precipitate in a stained biological sample is to determine the optical density of the stained sample. The optical density is compared to a calibration curve generated from control cells whose expression level of the target protein and gene are known. The disclosure provides the ability to analyze a combination of a protein target and a nucleic acid target in a sample.

The disclosure provides a system for and method of accurately determining the status of a nucleic acid target molecule (e.g., gene copy number) in a biological sample (e.g., a tissue sample). In one aspect, the disclosure provides a method of accurately determining the status of two or more diagnostic target molecules simultaneously in a biological sample (e.g., tissue sample). The disclosure includes a system for and method of accurately determining the status of a protein target and a nucleic acid target in a single biological sample using image analysis.

The methods and systems of the disclosure use image analysis to correlate the optical density of a chromogenic stain (e.g., a colored precipitate) to the concentration of a target molecule in a biological sample. The methods and systems use CISH in combination with IHC to accurately determine the status of two independent target molecules. A computer-aided image analysis system is used to process and analyze optical images of a chromagen-stained tissue or cell sample and to determine the optical density of the stained tissue or cell sample.

A polynucleotide or oligonucleotide refers to a polymeric form of nucleotides. The nucleotides can be ribonucleotides, deoxyribonucleotides, or modified forms of either nucleotide. A nucleotide includes any of the known base analogs of DNA and RNA including, but not limited to, 4-acetylcytosine, 8-hydroxy-N-6-methyladenosine, aziridinylcytosine, pseudoisocytosine, 5-(carboxyhydroxylmethyl) uracil, 5-fluorouracil, 5-bromouracil, 5-carboxymethylaminomethyl-2-thiouracil, 5-carboxymethyl-aminomethyluracil, dihydrouracil, inosine, N6-isopentenyladenine, 1-methyladenine, 1-methylpseudouracil, 1-methylguanine, 1-methylinosine, 2,2-dimethylguanine, 2-methyladenine, 2-methylguanine, 3-methylcytosine, 5-methylcytosine, N6-methyladenine, 7 methylguanine, 5-methylaminomethyluracil, 5-methoxyaminomethyl-2-thiour-acil, beta-D-mannosylqueosine, 5′-methoxycarbonylmethyluracil, 5-methoxyuracil, 2-methylthio-N-6-isopentenyladenine, uracil-5-oxyacetic acid methylester, uracil-5-oxyacetic acid, oxybutoxosine, pseudouracil, queosine, 2-thiocytosine, 5-methyl-2-thiouracil, 2-thiouracil, 4-thiouracil, 5-methyluracil, N-uracil-5-oxyacetic acid methylester, uracil-5-oxyacetic acid, pseudouracil, queosine, 2-thiocytosine, and 2,6-diaminopurine. A polynucleotide or oligonucleotide includes single- and double-stranded DNA, DNA that is a mixture of single- and double-stranded regions, single- and double-stranded RNA, and RNA that is mixture of single- and double-stranded regions, hybrid molecules comprising DNA and RNA that may be single-stranded or, more typically, double-stranded or a mixture of single- and double-stranded regions.

As used herein, the term “hybridization” is used in reference to the pairing of complementary nucleic acids. Hybridization and the strength of hybridization (i.e., the strength of the association between the nucleic acids) is impacted by such factors as the degree of complementary between the nucleic acids, stringency of the conditions involved, and the like. Depending on the application, varying conditions of hybridization can be used to achieve varying degrees of selectivity of the probe towards a target polynucleotide in a sample. For applications requiring high selectivity, relatively stringent conditions can be used, such as low salt and/or high temperature conditions, such as provided by a salt concentration of from about 0.02 M to about 0.15 M salt at temperatures of from about 50° C. to about 70° C. For applications requiring less selectivity, less stringent hybridization conditions can be used. For example, salt conditions from about 0.14 M to about 0.9M salt, at temperatures ranging form about 20° C. to about 55° C. The presence of a hybridized complex comprising the probe and a complementary polynucleotide from the sample indicates the presence of a target polynucleotide or gene in the sample.

As used herein, the term “probe” refers to an oligonucleotide, whether occurring naturally as in a purified restriction digest or produced synthetically, recombinantly or by amplification (e.g., PCR), which is capable of hybridizing to a target polynucleotide or oligonucleotide of interest in a sample (e.g., a biological specimen). Probes may be single-stranded or double-stranded. Probes are useful in the detection and identification of particular gene sequences (e.g., HER-2/neu). A probe is labeled with a “reporter molecule,” so that the probe may be detected. Reporter molecules include, but are not limited, to enzyme moieties, fluorescent moieties, radioactive moieties, and luminescent moieties.

Chromogenic in situ hybridization (CISH) is a technique that allows in situ hybridization methods to be performed and detected with a bright-field microscope, instead of a fluorescence microscope as required for FISH. While FISH requires expensive fluorescence microscopes, CISH allows detection with standard light (bright-field) microscopes. In addition, fluorescence signals tend to fade over time, while chromogenic techniques do not generally fade allowing the tissue samples to be archived and reviewed later. Furthermore, CISH techniques allow larger regions of tissue sections to be scanned rapidly after CISH counterstaining since morphological detail is readily apparent using low power objectives, while FISH detection generally requires substantially higher magnification.

General chromogenic/colorimetric in situ hybridization methods are described in WO0026415 to Fletcher et al. (herein incorporated by reference for all purposes). Particular reagents and steps for performing CISH on formalin-fixed, paraffin-embedded (FFPE) tissue samples are known in the art. Generally, the conditions used for in situ hybridization involve the fixation of tissue or other biological sample onto a surface, prehybridization treatment to increase the accessibility of target nucleic acid sequences in the sample (and to reduce non-specific binding), hybridization of a labeled oligonucleotide probe to the target polynucleotide, post-hybridization washes to remove unbound probe, and detection of the hybridized probes.

Once a sample is stained and treated by CISH and/or IHC, the sample is then analyzed on an automated microscope system. The automated microscope system carries out automated processing, image acquisition, identification and quantitation of objects or areas of interest (e.g. polypeptides and polynucleotide quantitations).

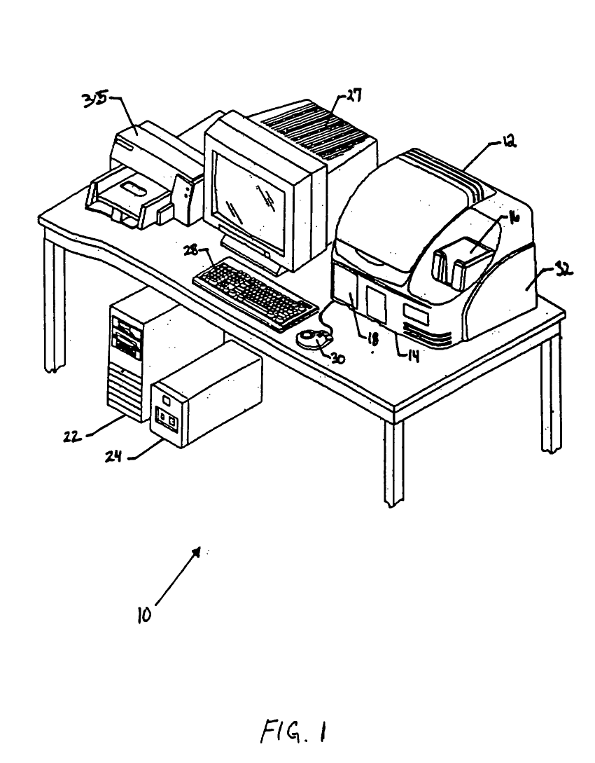

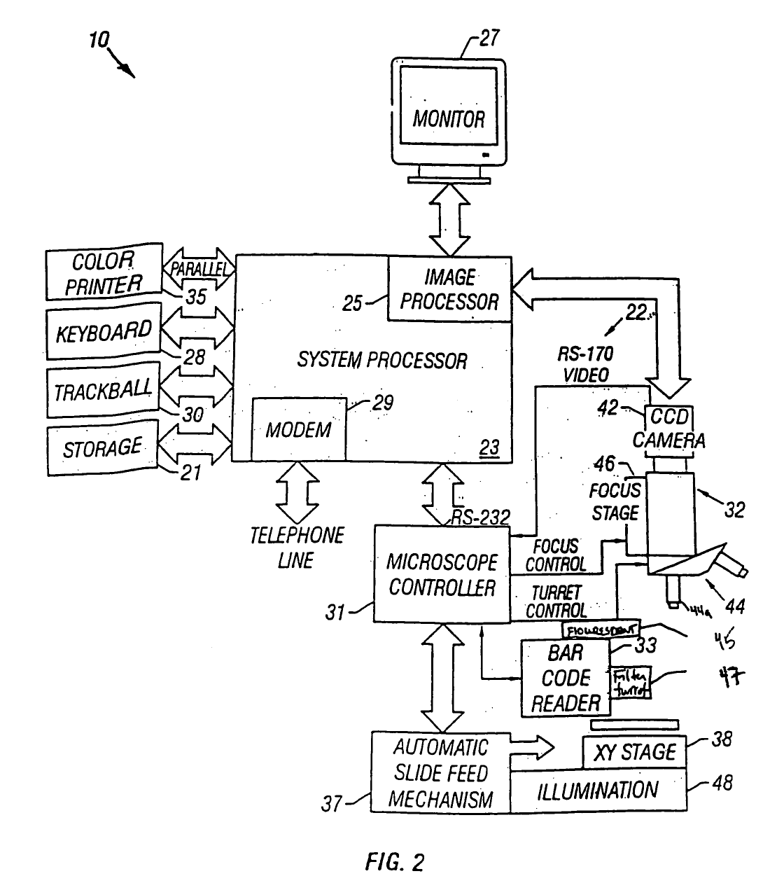

Referring now to FIGS. 1 and 2, an apparatus for automated cell analysis of biological samples is generally indicated by reference numeral 10 as shown in perspective view in FIG. 1 and in block diagram form in FIG. 2. The apparatus 10 comprises a microscope subsystem 32 housed in a housing 12. The housing 12 includes a slide carrier input hopper 16 and a slide carrier output hopper 18. A door 14 in the housing 12 secures the microscope subsystem from the external environment. A computer subsystem comprises a computer 22 having at least one system processor 23, and a communications modem 29. The computer subsystem further includes a computer/image monitor 27 and other external peripherals including storage device 21, a pointing device, such as a track ball or mouse device 30, a user input device, such as a touch screen, keyboard, or voice recognition unit 28 and color printer 35. An external power supply 24 is also shown for power outage protection. The apparatus 10 further includes an optical sensing array 42, such as, for example, a CCD camera, for acquiring images. Microscope movements are under the control of system processor 23 through a number of microscope-subsystem functions described further in detail. An automatic slide feed mechanism in conjunction with X-Y stage 38 provide automatic slide handling in the apparatus 10. An illumination 48 comprising a bright field transmitted light source projects light onto a sample on the X-Y stage 38, which is subsequently imaged through the microscope subsystem 32 and acquired through optical sensing array 42 for processing by the system processor 23. A Z stage or focus stage 46 under control of the system processor 23 provides displacement of the microscope subsystem in the Z plane for focusing. The microscope subsystem 32 further includes a motorized objective turret 44 for selection of objectives.

The apparatus 10 may further include a fluorescent excitation light source 45 and may further include a plurality of fluorescent filters on a turret or wheel 47. Alternatively, a filter wheel may have an electronically tunable filter.

The purpose of the apparatus 10 is for the automatic scanning of prepared microscope slides for the detection of candidate objects or areas of interest or rare events such as normal and abnormal cells, e.g., tumor cells. In one aspect, the apparatus 10 is capable of detecting rare events, e.g., events in which there may be only one candidate object of interest per several hundred thousand objects, e.g., one to five candidate objects of interest per 2 square centimeter area of the slide. The apparatus 10 automatically locates and can count candidate objects of interest noting the coordinates or location of the candidate object of interest on a slide based upon color, size and shape characteristics. A number of stains can be used to stain candidate objects of interest and other objects (e.g., normal cells) different colors so that such cells can be distinguished from each other (as described herein). In addition, various antibodies directed to various markers and oligonucleotide probes directed to genes can be labeled with a chromagen and used to detect and quantify various markers and gene expression.

A biological sample may be prepared with a reagent to obtain a colored insoluble precipitate. As one step in the methods and systems of the disclosure, an apparatus 10 is used to detect this precipitate as a candidate object of interest. During operation of the apparatus 10, a pathologist or laboratory technician mounts slides onto slide carriers. Each slide may contain a single sample or a plurality of samples (e.g., a tissue microarray). Each slide carrier can be designed to hold a number of slides from about 1-50 or more. A number of slide carriers are then loaded into input hopper 16 (see FIG. 1). The operator can specify the size, shape and location of the area to be scanned or alternatively, the system can automatically locate an area. The operator then commands the system to begin automated scanning of the slides through a graphical user interface. Unattended scanning begins with the automatic loading of the first carrier and slide onto the precision motorized X-Y stage 38. In one aspect of the disclosure, a bar code label affixed to the slide or slide carrier is read by a bar code reader 33 during this loading operation. Each slide is then scanned or imaged at a desired magnification, for example, 4× or 10×, to identify candidate cells or objects of interest based on their color, size and shape characteristics or to quantitant the overall color composition of the image. The term “coordinate” or “address” is used to mean a particular location on a slide or sample. The coordinate or address can be identified by any number of means including, for example, X-Y coordinates, r-O coordinates, polar, vector or other coordinate systems known in the art. In one aspect of the disclosure a slide is imaged or scanned under a first parameter comprising a desired magnification and using a bright field light source from illumination 48 (see FIG. 2) to identify a candidate cell or object of interest.

The methods, systems, and apparatus of the disclosure may obtain a low magnification image of a candidate cell or object of interest and then return to each candidate cell or object of interest based upon the previously stored coordinates to reimage and refocus at a higher magnification such as 40×. To avoid missing candidate cells or objects of interest, the system can process low magnification images by reconstructing the image from individual fields of view and then determine objects of interest. In this manner, objects of interest that overlap more than one objective field of view may be identified. The apparatus comprises a storage device 21 that can be used to store an image of a candidate cell or object of interest for later review by a pathologist or to store identified coordinates for later use in processing a sample or a subsample. The storage device 21 can be a removable hard drive, DAT tape, local hard drive, optical disk, or may be an external storage system whereby the data is transmitted to a remote site for review or storage. In one aspect, stored images can be overlapped and/or viewed in a mosaic of images for further review (as discussed more fully herein). Apparatus 10 can also be used for fluorescent imaging (e.g., in FISH techniques) of prepared microscope slides for the detection of candidate objects of interest such as normal and abnormal cells, e.g., tumor cells.

Where a sample is first stained with a first reagent and then subsequently stained with one or more additional reagent, the apparatus 10 can automatically locate the coordinates of previously identified candidate cells or objects of interest based upon the techniques described above. A bar code label affixed to a slide or slide carrier is read by a bar code reader 33 and provides the system with information including, for example, information about the scanning parameters including the type of light source or the excitation light wavelength to use.

The methods, system, and apparatus of the disclosure can obtain a first image using a transmitted light source at either a low magnification or high magnification of a candidate cell or object of interest and then return to the coordinates (or corrected coordinates) associated with each candidate cell or object of interest in the same sample or a related subsample using different imaging techniques based upon different reagents used. For example, the methods, system, and apparatus of the disclosure can obtain a first image using a transmitted light source at either a low magnification or high magnification of a candidate cell or object of interest and then return to the coordinates (or corrected coordinates) associated with each candidate cell or object of interest in the same sample or a related subsample to obtain a second image using the same or different imaging techniques. Images can be stored on a storage device 21 that can be used to store an image of a candidate cell or object of interest for later review by a pathologist.

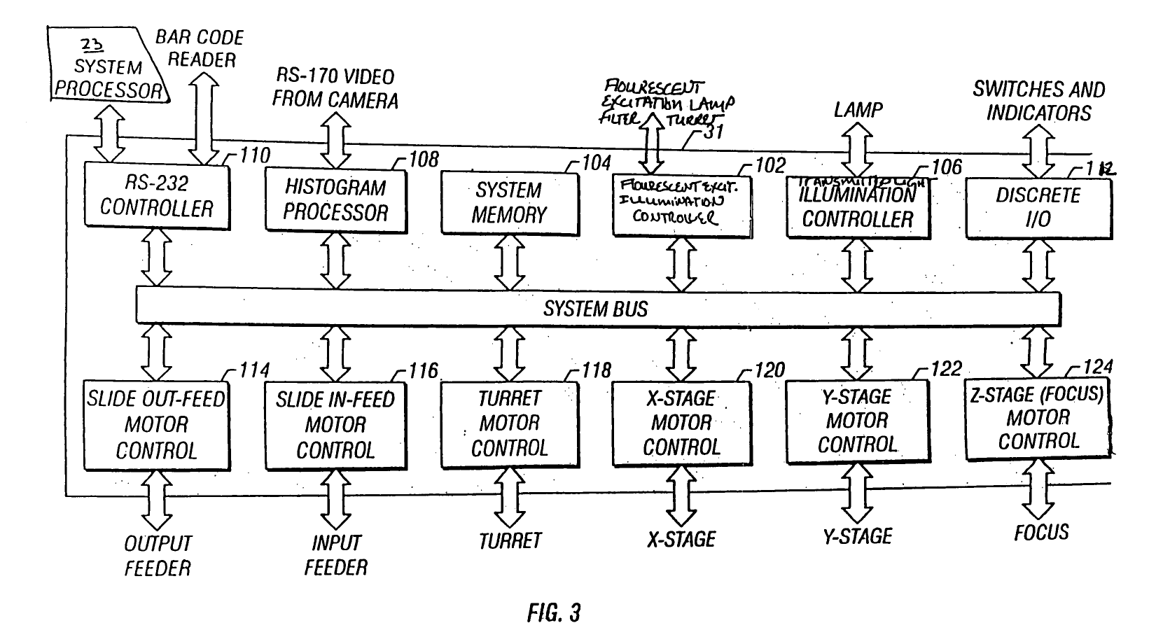

Light source management is performed using the system processor 23 through illumination controller 106 and may also control fluorescent light, when present through the fluorescent controller 102 (see, FIG. 3). During processing of images in transmitted light microscopy the fluorescent excitation light source is off or blocked such that excitation light from the fluorescent light source does not contact the sample. When fluorescent images are being obtained the transmitted light source is off or blocked such that the transmitted light does not pass through the sample while the sample is contacted by fluorescent excitation light from fluorescent excitation light source 45.

Having described the overall operation of the apparatus 10 from a high level, the further details of the apparatus will now be described. Referring to FIG. 3, the microscope controller 31 is shown in more detail. The microscope controller 31 includes a number of subsystems. The apparatus system processor 23 controls these subsystems. The system processor 23 controls a set of motor—control subsystems 114 through 124, which control the input and output feeder, the motorized turret 44, the X-Y stage 38, and the Z stage 46 (FIG. 2). The system processor 23 further controls a transmitted light illumination controller 106 for control of substage illumination 48 bright field transmitted light source and may, if present, control a fluorescent excitation illumination controller 102 for control of fluorescent excitation light source 45 and/or filter turret 47. The transmitted light illumination controller 106 is used in conjunction with camera and image collection adjustments to compensate for the variations in light level in various samples. The light control software samples the output from the camera at intervals (such as between loading of slide carriers), and commands the transmitted light illumination controller 106 to adjust the light or image collection functions to the desired levels. In this way, light control is automatic and transparent to the user and adds no additional time to system operation. Similarly, when present, fluorescent excitation illumination controller 102 is used in conjunction with the camera and image collection adjustments to compensate for the variations in fluorescence in various samples. The light control software samples the output from the camera at intervals (such as between loading of slide carriers and may include sampling during image collection), and commands the fluorescent excitation illumination controller 102 to adjust the fluorescent excitation light or image exposure time to a desired level. In addition, the fluorescent excitation illumination controller 102 may control the filter wheel or wavelength 47. The system processor 23 is a high performance processor of at least 200 MHz, for example, the system processor may comprise dual parallel, Intel, 1 GHZ devices. Advances in processors are being routinely made in the computer industry. Accordingly, the disclosure should not be limited by the type of processor or speed of the processor disclosed herein.

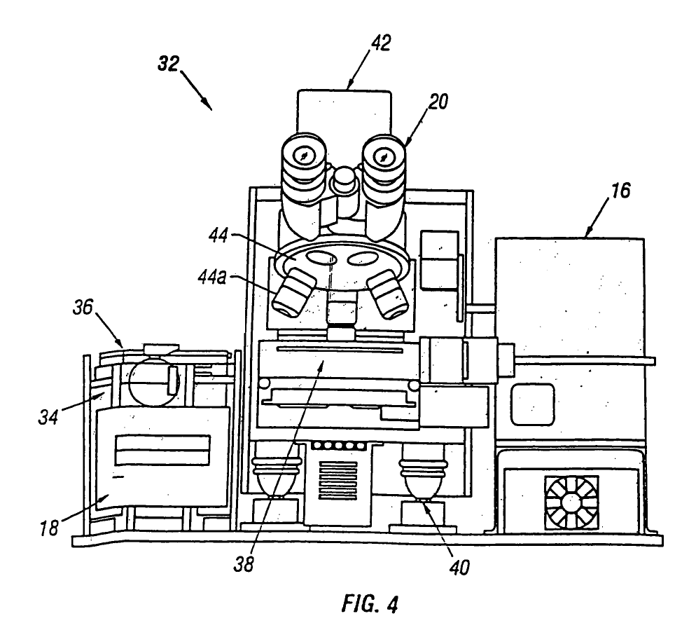

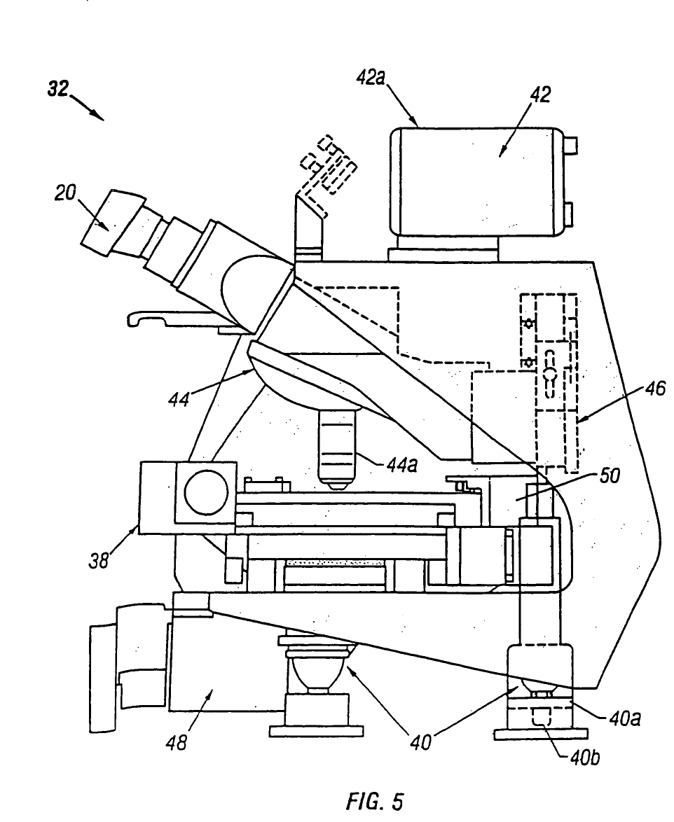

Referring now to FIGS. 4 and 5, further detail of the apparatus 10 is shown. FIG. 4 shows a plan view of the apparatus 10 with the housing 12 removed. Shown is slide carrier unloading assembly 34 and unloading platform 36 which in conjunction with slide carrier output hopper 18 function to receive slide carriers which have been analyzed. Vibration isolation mounts 40, shown in further detail in FIG. 5, are provided to isolate the microscope subsystem 32 from mechanical shock and vibration that can occur in a typical laboratory environment. In addition to external sources of vibration, the high-speed operation of the X-Y stage 38 can induce vibration into the microscope subsystem 32. Such sources of vibration can be isolated from the electro-optical subsystems to avoid any undesirable effects on image quality. The isolation mounts 40 comprise a spring 40a and piston 40b (see FIG. 5) submerged in a high viscosity silicon gel, which is enclosed in an elastomer membrane bonded to a casing to achieve damping factors on the order of about 17 to 20%. Other dampening devices are known in the art and may be substituted or combined with the dampening device provided herein. Occulars 20 are shown in FIGS. 4 and 5, however, their presence is an optional feature. The occulars 20 may be absent without departing from the advantages or functionality of the system.

It is noted that apparatus 10 operates autonomously, e.g., a clinician initiates apparatus 10 and apparatus 10 operates automatically without human intervention so long as a supply of microscope slides is available at its in-feed stage and no system errors occur. At any time, however, a clinician may view and/or manipulate the digital image of any given slide for the inspection and analysis of any given specimen.

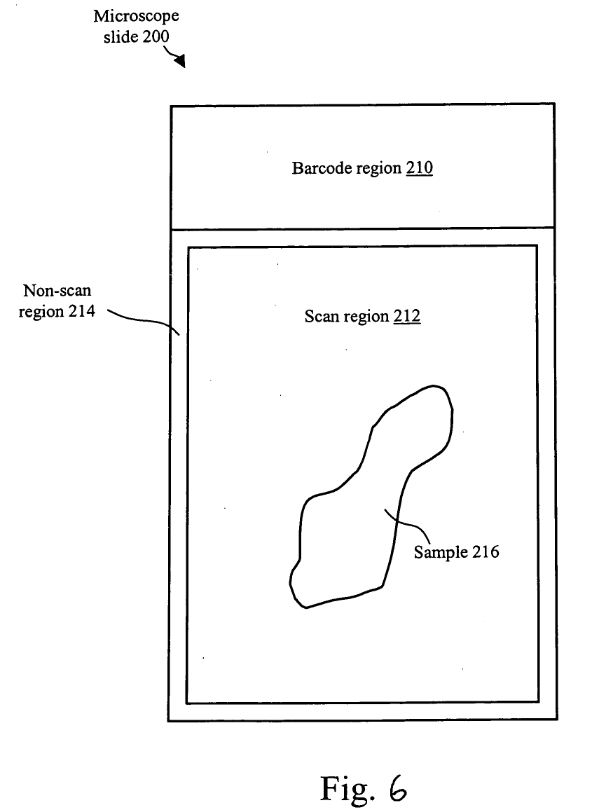

Referring to FIG. 6, sample 216 is typically stained for any material of diagnostic significance (i.e., target molecules) such as cellular proteins that are aberrantly expressed or nucleic acid abnormalities in diseased tissues. In one example, the sample is a tissue sample such as a breast tissue sample that is stained for HER2/neu gene amplification. The HER2/neu gene amplification method uses standard CISH protocols and commercially available hybridization systems such as SPoT-light HER2 DNA Probe and Detection Kit (ZYMED Laboratories, Inc., South San Francisco, Calif.).

A breast tissue sample (either the same or different) may be stained for HER2/neu protein. The HER2/neu protein method uses standard IHC protocols and an anti-HER2/neu staining system such as a commercially available kit provided by DAKO (Carpinteria, Calif.).

In one example, the sample is a tissue sample such as a breast tissue sample that is first stained for HER2/neu protein and subsequently stained for HER2/neu gene amplification using IHC and CISH, respectively. Alternatively, the same sample is stained simultaneously with chromagens linked to antibodies that interact with a target protein (e.g., IHC methods) and oligonucleotide probes that interact with genes or RNA transcripts contained in a cell (e.g. CISH) that yield different colors.

Sample 216 can also be counterstained with a second or third dye (as the case maybe) to enhance the appearance of the tissue sample (e.g., to outline cells in tissue sample). For example, a target molecule (e.g., HER2/neu protein) is stained with a brown dye, while the rest of the tissue is stained with a common blue dye (e.g., methyl green) that is used to mark tissue.

The amount of a target molecule in stained sample is typically determined using calibration curves that relate the amount and degree of target-specific staining to the amount of the target molecule in the sample.

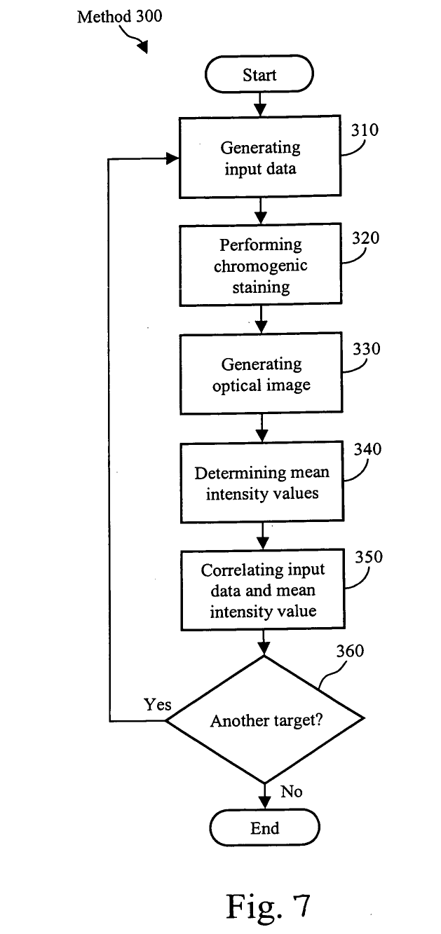

FIG. 7 illustrates a flow diagram of a method 300 of establishing a calibration curve for accurately determining a target molecule in sample 216 using image analysis. FIGS. 1 and 6 are referenced throughout the method steps of method 300. Further, it is noted that the use of method 300 of establishing a calibration curve is not limited to apparatus 10; method 300 may be used with any generalized imaging system or application.

At box 310 a user, e.g., a pathologist or technician, selects and executes a standard method to generate reference input data for a calibration curve. A calibration curve for CISH includes reference input data for the number of copies of a target gene. In one example, reference input data for CISH is obtained using a plurality of cultured cell lines each containing a different copy number of the target gene (e.g., the HER2/neu gene). The copy number is obtained using standard methods such as FISH and fluorescence microscopy. In FISH, copy number data is typically determined by counting the number of fluorescent “spots” in the nuclei of stained cells.

A calibration curve for IHC includes reference input data for the level of expression of a target protein. In one example, reference data for IHC is obtained using a plurality of cultured cell lines each expressing the target protein at a different level (e.g., the HER2/neu protein). The level of expression is obtained using standard methods such as an enzyme linked immunosorbant assay (ELISA). Method 300 proceeds to box 320.

In box 320 a user prepares a sample on microscope slide. The sample is, for example, a second set of cultured cell lines such as those described in 310. The sample provides optical density data for a target molecule. The sample is stained for a target molecule using standard CISH or IHC methods. For example, the sample is stained using standard CISH methods for determining amplification of a target gene (e.g., the HER2/neu gene). The CISH dye, for example, is NovaRED (Vector Laboratories, Burlingame, Calif.), which forms a visible, insoluble, brownish-red precipitate in the presence of a horseradish peroxidase antibody marker. The rate of deposition of the dye is linearly proportional to the number of target molecules. A sample may be stained with one or more chromogenic dyes.

At 330, an optical image of a sample on a microscope slide is generated using a computer-aided image analysis system such as apparatus 10 as described in reference to FIG. 1. In one example, a sample is stained using standard CISH methods for determining amplification of a target gene (e.g., the HER2/neu gene) and counterstained with a common blue dye (e.g., methyl green) to mark cells and tissues. The cells in the sample are outlined in blue and the nuclei include brownish-red spots.

At 340 the mean intensity value of a selected color (e.g., blue or brownish-red) is determined from the pixels in the image. In one embodiment, the mean intensity value is determined using color space transforms to build masks, as described in U.S. Pat. No. 6,697,509 (the disclosure of which is incorporated herein). In this method, a user selects, e.g., with a pointing device such as a mouse, a region of the optical image of the sample to process. The pixels outside the selected region are masked. A second mask is built for the selected color using predetermined color thresholds to further differentiate the selected color. Pixels that fall outside the color threshold corresponding to the selected color are masked.

After the pixels outside of the selected region and outside the selected color threshold have been masked, the image including the remaining pixels is scored. The image is scored by measuring the color value of a pixel that is the complement of the selected color. For example, the blue value of a pixel is measured in a sample stained with diaminobenzidine tetrahydrocholoride (DAB; i.e., brown color) because blue is the complement of brown. A pixel appears brown because blue light is blocked more than red or green, and therefore the decrease in blue can be interpreted as the quantity of DAB.

The blue color value of a pixel is subtracted from the average blue value of the background. The average background value color is determined, for example, from a stored image file taken of the background. This operation is repeated for the remaining unmasked pixels and the mean intensity value determined by dividing the accumulated result by the number of pixels in the select region that meet the color threshold criteria.

Referring now to FIG. 7, at 350 the mean intensity value for a selected color is correlated to a calibration curve. The calibration curve is used to convert a reading in instrument units (i.e., mean intensity) to input data units (e.g., gene copy number).

At 360 a user determines whether a calibration curve is required for analysis of another target molecule (i.e., another stain). An additional target molecule is typically distinguished using a second chromogenic dye. If yes, method 300 returns to 310. If no, method 300 ends.

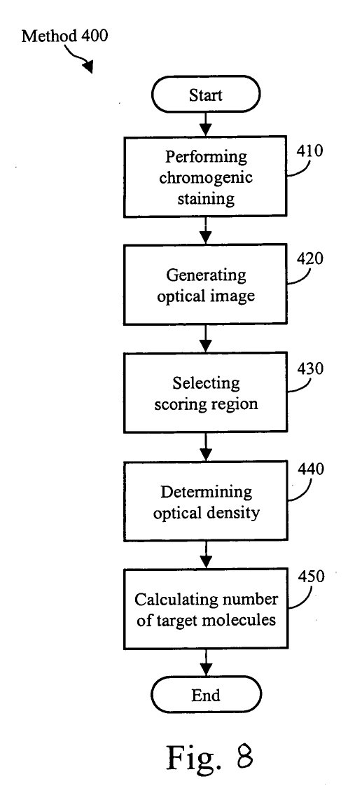

FIG. 8 illustrates a flow diagram of a method 400 of accurately determining the status of one or more target molecules in a biological sample. Method 400 uses the image-processing algorithm that transforms the image into a new color space such that the optical density of each stain is determined in a different channel (i.e., the process performed in 340 of method 300). Method 400 is not limited to this approach, and other alternative image processing and image analysis algorithms can be used. Method 400 provides an accurate means of determining the number of target molecules, such as the number of gene copies, without manual counting.

Referring to FIG. 8, at 410 a user prepares a sample on microscope slide. The sample is, for example, a tissue sample such as a breast tissue sample. In one example, the sample is stained using standard IHC methods for determining the expression levels of a protein (e.g., the HER2/neu protein). The IHC dye is, for example, DAB, which forms a visible, insoluble, brown precipitate in the presence of a horseradish peroxidase antibody marker. The sample is also stained using standard CISH methods for determining amplification levels of a target gene (e.g., HER2/neu gene) using a second dye, for example, a brownish-red dye such as NovaRED. The sample is also stained with a third dye that enhances the appearance of individual cells in the tissue sample, for example, a blue dye such as methyl green.

At 420 an optical image of the sample on the microscope slide is generated using a computer-aided image analysis system such as apparatus 10 as described in reference to FIG. 1. The optical image for a cell in a sample that stains positively for HER2/neu gene amplification and HER2/neu protein expression is outlined in brown (i.e., HER2/neu is a cytoplasmic membrane protein) and includes brownish-red spots in its nucleus. In a normal cell, two brownish-red spots are typically seen (i.e., two copies of the HER2/neu gene). In an abnormal cell, more than two brownish-red spots are typically seen.

The system may automatically select an area of interest comprising colors indicative of a tumor. Alternatively, a user selects, e.g., with a pointing device such as a mouse, a region of the optical image of the sample to process 430. The selection by the user may be necessary because the tissue sample may not necessarily be all tumors.

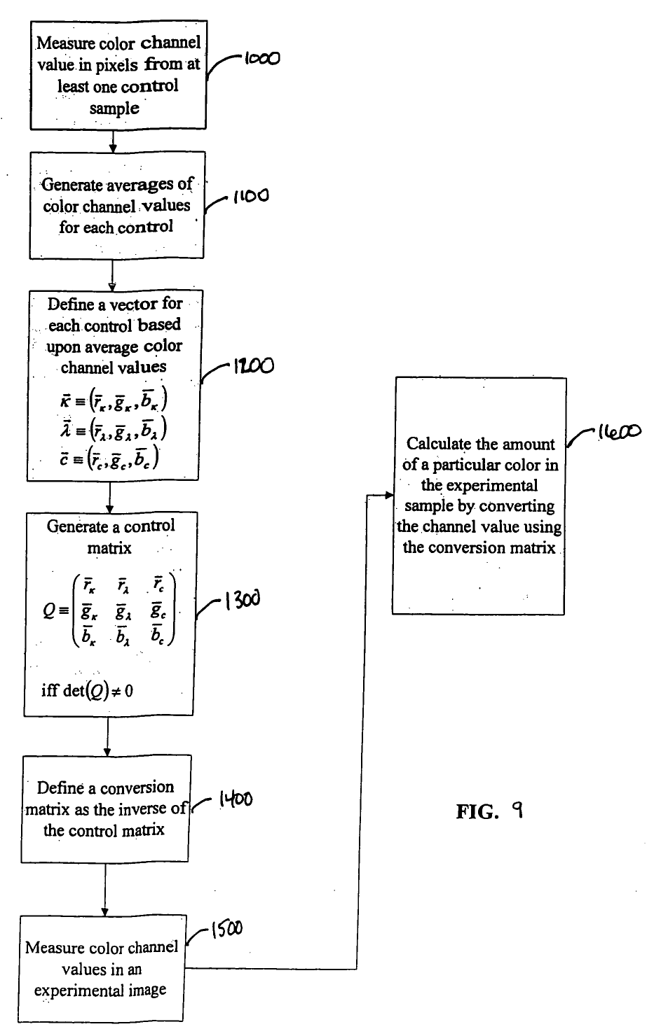

At 440 the optical density of a selected color (e.g., blue or brown) is determined from the pixels in the image. The optical density is determined using an image-processing algorithm that transforms the image into a new color space such that the optical density of each stain is determined in a different channel (i.e., the process performed in step 340 of method 300 and/or as described in FIG. 9). For example, the optical density of the brown dye is determined on one channel and the optical density of the brownish-red dye is determined on a second channel. Using this approach, a plurality of different stains can be imaged simultaneously.

At 450, the optical density data for each color dye is compared to the color-specific calibration curve generated in method 300 (see also FIG. 9). For example, optical density data for the brownish-red dye is compared to a calibration curve that converts the optical density data to numbers of gene copies. The optical density data for the brown dye is compared to a calibration curve that converts the optical density data to the amount of protein target present.

In an alternative embodiment, the amount of a light-absorbing stain is determined using an image analysis algorithm that transforms the image into a new color space in which each channel represents the absorption of light by one color of stain. In this method, the user selects, e.g., with a pointing device such as a mouse a region of the optical image of a sample to process. For each pixel in a stained sample, red, green, and blue color values are subtracted from red, green, and blue values of the white background of a microscope slide. This transformation defines a new color space that represents the amount of each color absorbed by the stain. For each color of stain (i.e., three different stains), a vector is defined that represents the average of red, green, and blue values for all the pixels in the selected region of the sample. The vectors define a color space (i.e., a color channel) that identifies red, green, and blue values for a stain and allows the amount of light absorbed by a given stain to be determined. The optical density (i.e., amount of light absorbed) is proportional to the amount of the corresponding stain in that area.

If the white of a clear space on the glass of a microscope slide or other sample is defined as: W≡(r_{w},g_{w},b_{w}), a new color space C can be defined as: C≡(r_{w}−r,g_{w}−g,b_{w}−b). Using 3 control samples (e.g., slides) each comprising a color (e.g., a stain) with one of the colors (stains) to be measured (called κ, λ and C) and an experimental sample (e.g., a slide) comprising all 3 colors (e.g., all the stains) on which a sample to be measured is contained, the concentration of each color (e.g., stain) at each pixel can be measured using the following method.

For each control a vector of the average r, g and b values of all pixels is defined:
\vec{κ}≡(\overline{r}_{κ},\overline{g}_{κ},\overline{b}_{κ})
\vec{λ}≡(\overline{r}_{λ},\overline{g}_{λ},\overline{b}_{λ})
\vec{c}≡(\overline{r}_{c},\overline{g}_{c},\overline{b}_{c})
The matrix is then defined as:

$$Q ≡ ( \begin{matrix}{\overline{r}}_{κ} & {\overline{r}}_{λ} & {\overline{r}}_{c} \\ {\overline{g}}_{κ} & {\overline{g}}_{λ} & {\overline{g}}_{c} \\ {\overline{b}}_{κ} & {\overline{b}}_{λ} & {\overline{b}}_{c}\end{matrix} )$$

$$iff det ( Q ) \neq 0$$

Then Q is invertible and the 3 colors (e.g., stains) are genuinely different colors (as opposed to shades of the same color). The magnitude of det(Q) is inversely proportional to the noise the presence of each of the colors (e.g., stains) imposes on an attempt to measure another using this method. Where a sample comprises a fluorescent images, the values of r, g, and b (e.g., the color channel) are the absolute values and not an average.
In addition:
\vec{κ},\vec{λ},\vec{c}

Forms a basis of a new color space E and P≡Q⁻¹ is a transform from C to E.

Therefore for any pixel (r,g,b) in C on the experimental sample (e.g., slide)

$$( \begin{matrix}k \\ l \\ c\end{matrix} ) = P ( \begin{matrix}r \\ g \\ b\end{matrix} )$$

can be calculated. Where k will be proportional to the concentration of color (e.g., stain) κ; l will be proportional to the concentration of color (e.g., stain) λ; and c will be proportional to the concentration of color (e.g., stain) C.

The IOD of some area of the sample (e.g., a slide, for instance, a cell or area of tissue on the slide) measured in one of these new channels will be proportional to the amount of the corresponding color (e.g., stain) in that area. Using a control, a conversion factor can be calculated by the methods described above and used to directly and independently determine the amount of the 3 colors in the sample (e.g., stains in the sample).

Furthermore for any pixel on the image of the experimental sample (e.g., slide):

$$( \begin{matrix}{r}^{′} \\ {g}^{′} \\ {b}^{′}\end{matrix} ) = Q ( \begin{matrix}k \\ 0 \\ 0\end{matrix} )$$

can be calculated by substituting 0 for the values of 2 of the colors (e.g., stains) and converting back to the original color space:

$$( \begin{matrix}{r}_{o}^{′} \\ {g}_{o}^{′} \\ {b}_{o}^{′}\end{matrix} ) = ( \begin{matrix}{r}_{w} - {r}^{′} \\ {g}_{w} - {g}^{′} \\ {b}_{w} - {b}^{′}\end{matrix} )$$

The resulting values will be the appearance the pixel would have had if those 2 colors (e.g., stains) had not been used. Using the above algorithm and method an image that shows what the sample (e.g., slide) would have looked like if one or two of the colors/stains had not been used can be produced. In some aspects, a color/stain may be so dark that some pixels have a reading of 0.

During image acquisition and processing, an algorithm of the disclosure is used to quantify a color in a sample comprising multiple colors (e.g., one color that stains proteins by IHC and another that stain polynucleotides by CISH). Typically a series of control slides (e.g., 2 or more control slides) comprising a single color (e.g., a single stain rendering a color precipitate) will be imaged by the system (see, FIG. 9 at 1000). A measure of a color channel value in a plurality of pixels comprising a single color of interest is made (1000). This information defines a vector for each of the plurality of control samples, wherein each vector comprises an average of each color channel value present in the control (FIG. 9 at 1200). This information is then used to define a control matrix comprising each of the averages for each of the color channels (1300). A conversion matrix is then generated comprising the inverse of the control matrix (1400). Once the control measurements are made, the system then measures color channel values in an image of an experimental sample comprising a plurality of colors of interest (1500), each of the pixels comprising a plurality of color channels. The amount of a particular color in the experimental sample can then be calculated by converting the channel values in the experimental sample using the conversion matrix (1600). The disclosure uses the Red, Green, Blue (RGB), in the specific examples, however one of skill in the art will recognize that various other colors and color space may be used in the methods of the disclosure. It will also be recognized that the number of colors in the experimental sample can be less than or equal to the number of color channels measure in the controls. The methods of the disclosure may be combined with additional imaging algorithms and processes to identify objects or areas of interest in a sample. Such imaging process may be performed prior to, concurrently with, or after the exemplary process set forth in FIGS. 7-9.

The number of target molecules can be determined on a cell-by-cell basis by determining the optical densities for each color in individual cells. Alternatively, the optical density can be determined over the entire selected region to provide a number that is proportional to the average number of target molecules in all the cells encompassed in the selected region.

Although the disclosure describes breast tissue and HER2/new quantations; other samples are applicable to the methods of the disclosure. A biological sample and/or subsample can comprise biological materials obtained from or derived from a living organism. Typically a biological sample will comprise proteins, polynucleotides, organic material, cells, tissue, and any combination of the foregoing. Such samples include, but are not limited to, hair, skin, tissue, cultured cells, cultured cell media, and biological fluids. A tissue is a mass of connected cells and/or extracellular matrix material (e.g., CNS tissue, neural tissue, eye tissue, placental tissue, mammary gland tissue, gastrointestinal tissue, musculoskeletal tissue, genitourinary tissue, and the like) derived from, for example, a human or other mammal and includes the connecting material and the liquid material in association with the cells and/or tissues. A biological fluid is a liquid material derived from, for example, a human or other mammal. Such biological fluids include, but are not limited to, blood, plasma, serum, serum derivatives, bile, phlegm, saliva, sweat, amniotic fluid, mammary fluid, and cerebrospinal fluid (CSF), such as lumbar or ventricular CSF. A sample also may be media containing cells or biological material.

A biological sample may be embedded in embedding media such as paraffin or other waxes, gelatin, agar, polyethylene glycols, polyvinyl alcohol, celloidin, nitrocelluloses, methyl and butyl methacrylate resins or epoxy resins, which are polymerized after they infiltrate the specimen. Water-soluble embedding media such as polyvinyl alcohol, carbowax (polyethylene glycols), gelatin, and agar, may be used directly on specimens. Water-insoluble embedding media such as paraffin and nitrocellulose require that specimens be dehydrated in several changes of solvent such as ethyl alcohol, acetone, or isopropyl alcohol and then be immersed in a solvent in which the embedding medium is soluble. In the case where the embedding medium is paraffin, suitable solvents for the paraffin are xylene, toluene, benzene, petroleum, ether, chloroform, carbon tetrachloride, carbon bisulfide, and cedar oil. Typically a tissue sample is immersed in two or three baths of the paraffin solvent after the tissue is dehydrated and before the tissue sample is embedded in paraffin. Embedding medium includes, for examples, any synthetic or natural matrix suitable for embedding a sample in preparation for tissue sectioning.

A tissue sample may be a conventionally fixed tissue sample, tissue samples fixed in special fixatives, or may be an unfixed sample (e.g., freeze-dried tissue samples). If a tissue sample is freeze-dried, it should be snap-frozen. Fixation of a tissue sample can be accomplished by cutting the tissue specimens to a thickness that is easily penetrated by fixing fluid. Examples of fixing fluids are aldehyde fixatives such as formaldehyde, formalin or formol, glyoxal, glutaraldehyde, hydroxyadipaldehyde, crotonaldehyde, methacrolein, acetaldehyde, pyruic aldehyde, malonaldehyde, malialdehyde, and succinaldehyde; chloral hydrate; diethylpyrocarbonate; alcohols such as methanol and ethanol; acetone; lead fixatives such as basic lead acetates and lead citrate; mercuric salts such as mercuric chloride; formaldehyde sublimates; sublimate dichromate fluids; chromates and chromic acid; and picric acid. Heat may also be used to fix tissue specimens by boiling the specimens in physiologic sodium chloride solution or distilled water for two to three minutes. Whichever fixation method is ultimately employed, the cellular structures of the tissue sample must be sufficiently hardened before they are embedded in a medium such as paraffin.

Using techniques such as those disclosed herein, a biological sample comprising a tissue may be embedded, sectioned, and fixed, whereby a single biopsy can render a plurality of subsamples upon sectioning. In one aspect, a plurality of subsamples corresponding to the number of stains to be used in a particular assay are treated with a single stain (i.e. as controls) and a subsample is then treated with a plurality of stains. As discussed below, such subsamples can be examined under different staining or fluorescent conditions thereby rendering a wealth of information about the tissue biopsy. In one aspect of the disclosure, an array of tissue samples may be prepared and located on a single slide. The generation of such tissue-microarrays are known in the art. Each tissue sample in the tissue-microarray may be stained and/or treated the same or differently using both automated techniques and manual techniques (see, e.g., Kononen et al. Nature Medicine, 4(7), 1998; and U.S. Pat. No. 6,103,518, the disclosures of which are incorporated herein by reference).

In another aspect, the disclosure provides a method whereby a single biological sample may be assayed or examined in many different ways. Under such conditions a sample may be stained or labeled with a plurality of reagents.

The biological sample and/or subsample can be contacted with a variety of reagents useful in determining and analyzing cellular molecules and mechanisms. Such reagents include, for example, polynucleotides, polypeptides, small molecules, and/or antibodies useful in in situ screening assays for detecting molecules that specifically bind to a marker present in a sample. Such assays can be used to detect, prognose, diagnose, or monitor various conditions, diseases, and disorders, or monitor the treatment thereof. A reagent can be detectably labeled such that the agent is detectable when bound or hybridized to its target marker or ligand. Such means for detectably labeling any of the foregoing reagents include an enzymatic, fluorescent, or radionuclide label. Other reporter means and labels are well known in the art. As used herein the term “stain” refers a detectable label which may be a colored precipitate, a chromogenic molecule, a fluorescent molecule, and the like.

A marker can be any cell component present in a sample that is identifiable by known microscopic, histologic, or molecular biology techniques. Markers can be used, for example, to distinguish neoplastic tissue from non-neoplastic tissue. Such markers can also be used to identify a molecular basis of a disease or disorder including a neoplastic disease or disorder. Such a marker can be, for example, a molecule present on a cell surface, an overexpressed target protein or nucleic acid, a nucleic acid mutation or a morphological characteristic of a cell present in a sample.

A reagent useful in the methods of the disclosure can be an antibody. Antibodies useful in the methods of the disclosure include intact polyclonal or monoclonal antibodies, as well as fragments thereof, such as Fab and F(ab′)2. For example, monoclonal antibodies are made from antigen containing fragments of a protein by methods well known to those skilled in the art (Kohler, et al., Nature, 256:495, 1975). Enzyme labels can be functionally attach whereby the enzyme acts on chromogenic substrates to render a colored precipitate at the location of the target marker.

A reagent useful in the methods of the disclosure includes a nucleic acid molecule (e.g., an oligonucleotide or polynucleotide). For example, in situ nucleic acid hybridization techniques are well known in the art and can be used to identify an RNA or DNA marker present in a sample or subsample. Screening procedures that rely on nucleic acid hybridization make it possible to identify a marker from any sample, provided the appropriate oligonucleotide or polynucleotide agent is available. For example, oligonucleotide agents, which can correspond to a part of a sequence encoding a target polypeptide (e.g., a cancer marker comprising a polypeptide), can be synthesized chemically or designed through molecular biology techniques. The polynucleotide encoding the target polypeptide can be deduced from the genetic code, however, the degeneracy of the code must be taken into account. For such screening, hybridization is typically performed under in situ conditions known to those skilled in the art.

Generally sample preparation includes the reaction of a sample or subsample with an agent the specifically interacts with molecules (e.g. a polynucleotide and a nucleic acid) in the sample. Examples of such agents include a monoclonal antibody, a polyclonal antiserum and an oligonucleotide or polynucleotide. Interaction of the agent with its cognate or binding partner can be detected using an enzymatic reaction, such as alkaline phosphatase or glucose oxidase or peroxidase to convert a soluble colorless substrate linked to the agent to a colored insoluble precipitate, or by directly conjugating a dye or molecule to the probe. In one aspect of the disclosure a first agent is labeled with a first label (e.g., a first substrate that gives rise to a precipitate) and a second agent is labeled with a second different substrate label. Examples of labels include enzymes that convert a soluble colorless substrate to a colored insoluble precipitate (e.g., alkaline phosphatase, glucose oxidase, or peroxidase). Other non-fluorescent agent include small molecule reagents that change color upon interaction with a particular chemical structure.

Denaturation and hybridization for purposes of CISH may be accomplished as one step (co-denaturing and hybridization), or as two steps (separate denaturation and hybridization). One general procedure for co-denaturation and hybridization is as follows. First, add the probe (e.g. 12-20 ul of a subtracted probe library) to the center of a cover slip. In other embodiments, the probe is added directly to the tissue sample. The slide with the tissue sample is then placed on a slide block or PCR machine or on a heating block with temperature display (or other heating device). Denaturation is conducted at approximately 94-95 degrees Celsius for about 5-10 minutes. The tissue sample on the slide is then incubated at approximately 37 degrees Celsius for about 16-24 hours. Incubation may be conducted, for example, in a dark humidity box (or other humidified chamber) or in the slide block of a PCR thermal cycler.

One general procedure for separate denaturation and hybridization is as follows. This procedures is useful, for example, when a PCR machine or heating blocks are not readily available. First, the tissue sample is denatured in denaturing buffer at about 75 degrees Celsius for about 5 minutes. Increases in temperature may be used for additional samples being denatured at the same time (e.g. add about 1 degree Celsius for each additional sample being denatured). Next, the slides are denatured with graded alcohols (e.g. 70% EtOH, 85% EtOH and 95% all for about 2 minutes at negative 20 degrees Celsius, and then 100% EtOH for about 2 minutes twice).

The tissue samples are then air dried, while the labeled probe is denatured at about 75 degrees Celsius for about 5 minutes. The denatured probe is then placed on ice. About 12-15 ul of the denatured probe is added to the center of a coverslip. The coverslip is then added to the appropriate tissue sample area, and the tissue sample is placed in a dark humid box (or other humidified chamber) at about 37° C. for about 14 hours.

In some instances, a hematoxylin/eosin (H/E) slide is prepared with a standard H/E protocol.

In another aspect, the disclosure provides automated methods for analysis of estrogen receptor and progesterone receptor. The estrogen and progesterone receptors, like other steroid hormone receptors, play a role in developmental processes and maintenance of hormone responsiveness in cells. Estrogen and progesterone receptor interaction with target genes is of importance in maintenance of normal cell function and is also involved in regulation of mammary tumor cell function. The expression of progesterone receptor and estrogen receptor in breast tumors is a useful indicator for subsequent hormone therapy. An anti-estrogen receptor antibody labels epithelial cells of breast carcinomas which express estrogen receptor. Accordingly, the disclosure provides a method whereby tumor cells are identified using a first reagent comprising and an antibody to a progesterone and/or estrogen receptor and a second reagent comprising obgonucleotides that hybridize to a polynucleotide encoding the progesterone and/or estrogen receptors, wherein the reagents are tagged with a detectable label or stain.

For example, the labeling of progesterone receptor has been demonstrated in the nuclei of cells from various histologic subtypes. An anti-progesterone receptor antibody labels epithelial cells of breast carcinomas which express progesterone receptors. An immunohistochemical assay of the progesterone receptor is performed using an anti-estrogen receptor antibody, for example the well-characterized 1A6 clone and methods similar to those of Pertchuk, et al. (Cancer 77: 2514-2519, 1996).

Metastasis is the biological process whereby a cancer spreads to a distant part of the body from its original site. A micrometastases is the presence of a small number of tumor cells, particularly in the lymph nodes and bone marrow. A metastatic recurring disease is similar to micrometastasis, but is detected after cancer therapy rather than before therapy. An immunohistochemical assay for MM/MRD is performed using a monoclonal antibody that reacts with an antigen (a metastatic-specific mucin) found in bladder, prostate and breast cancers. Similarly, a CISH array for MM/MRD is performed using an oligonucleotide probe that bydriges with a polynucleotide encoding an antigen (a metastution-specific mucin). An MM/MRD can be identified by staining cells to identify nucleic and cellular organelles or alternatively by staining cells to differentiate between bladder and other prostate cells. Subsamples corresponding to the original first subsample can then be stained with antibody and/or oligonucleotide to a mucin protein or polynucleotide, respectively, wherein the antibody and oligonucleotide are detectably labeled with a chromagen. In this way, a first subsample is prescreened to identify objects of interest including a particular cell type and then screened with a specific antibody and/or oligonucleotide to a molecule of interest associated with the object of interest. The first screening step allows for an automated system to identify the coordinates in a first subsample having the object of interest whereby the coordinates are then used to focus and obtaining images in a second subsample at the same coordinates.

Another example of the application of the disclosure includes the use of MIB-1. MIB-1 is an antibody that detects the antigen Ki-67. The clinical stage at first presentation is related to the proliferative index measured with Ki-67. High index values of Ki-67 are positively correlated with metastasis, death from neoplasia, low disease-free survival rates, and low overall survival rates. For example, a first agent (e.g., a staining agent) is used to identify an object of interest such as a marker for cancer cells. A diagnosis or prognosis of a subject may then be performed by further analyzing any object of interest for the presence of Ki-67 using an antibody that is detectably labeled or an oligonucleotide the specifically hybridges to a polynucleotide encoding Ki-67. The presence of a detectable label or stain at such coordinates is indicative of a correlation of the cancer cell with metastasis and/or survival rates.

In another aspect, microvessel density analysis can be performed and a determination of any cytokines, angiogenic agents, polynucleotides encoding such cytokines and angiogenic agents and the like, which are suspected of playing a role in the angiogenic activity identified. Angiogenesis is a characteristic of growing tumors. By identifying an angiogenic agent that is expressed or produced aberrantly compared to normal tissue, a therapeutic regimen can be identified that targets and modulates (e.g., increases or decreases) the angiogenic molecule or combination of molecules.

Overexpression of the p53 oncogene has been implicated as the most common genetic alteration in the development of human malignancies. Investigations of a variety of malignancies, including neoplasms of breast, colon, ovary, lung, liver, mesenchyme, bladder and myeloid, have suggested a contributing role of p53 mutation in the development of malignancy. The highest frequency of expression has been demonstrated in tumors of the breast, colon, and ovary. A wide variety of normal cells do express a wildtype form of p53 but generally in restricted amounts. Overexpression and mutation of p53 have not been recognized in benign tumors or in normal tissue. In addition, p53 has also be implicated as a cocontributor to tumors. For example, BRCA-1 has been used as marker for ovarian cancer, however p53 has also been implicated as playing a role in BRCA-1 ovarian cancers (Rose and Buller, Minerva Ginecol. 54(3):201-9, 2002). Using the methods of the disclosure a sample is stained for BRCA-1 with a first agent and objects of interest are identified using light microscopy. The same sample or a subsample, having substantially identical coordinates with respect to an object of interest, is then contacted with a second agent comprising a detectable label or stain that interacts with a p53 nucleic acid and/or polypeptide. The sample or subsample is then analyzed via microscopy to identify any detectable label associated with the second agent at the coordinates associated with the object of interest to determine the presence or absence of p53 nucleic acids or polypeptides. An anti-p53 antibody useful in this embodiment includes, for example, the well-characterized DO-7 clone.

In yet another aspect, and object of interest may be the p24 antigen of Human immunodeficiency virus (HIV). Anti-p24 antibodies are used to detect the p24 antigen to determine the presence of the HIV virus. Further assays can then be performed using CISH to determine the genetic composition of the HIV virus using labeled oligonucleotide probes and the like.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
measuring a plurality of colors in a biological sample on a slide, wherein at least a first color is associated with an IHC stained polypeptide and a second color is associated with a CISH stained polynucleotide;
determining an amount of IHC stained polypeptide in the sample and an amount of CISH stained polynucleotide by comparing the first color to a first standard and the second color to a second standard.

2. The method of claim 1, wherein the measuring is by an automated microscope system.

3. The method of claim 1, wherein the first color and the second color are the same color.

4. The method of claim 1, wherein the first color and the second color are different colors.

5. The method of claim 1, wherein the determining comprises
measuring a color channel value in a plurality of pixels from a plurality of standard samples, wherein each standard comprises a single color of interest;
defining a vector for each of the plurality of control samples, wherein each vector comprises an average of each color channel value present in the standard;
defining a matrix comprising each of the averages for each of the color channels;
defining a conversion matrix comprising the inverse of the matrix based upon the control measurements;
measuring color channel values in an image of the biological sample comprising the IHC stained polypeptide and a CISH stained polynucleotide, each of the pixels comprising a plurality of color channels; and
calculating the amount a polypeptide or polynucleotide by converting the channel values in the experimental sample using the conversion matrix.

6. The method of claim 1, wherein the plurality of colors are measured simultaneously.

7. The method of claim 1, wherein the plurality of colors are measured sequentially.

8. A computer implemented method of claim 1.

9. A computer program on computer readable medium comprising instructions to cause a computer to:
measure a plurality of colors in a biological sample on a slide, wherein at least a first color is associated with an IHC stained polypeptide and a second color is associated with a CISH stained polynucleotide;
determine an amount of IHC stained polypeptide in the sample and an amount of CISH stained polynucleotide by comparing the first color to a first standard and the second color to a second standard; and
outputting an indication of the amounts of polypeptide and polynucleotide.

10. The computer readable program of claim 9, wherein the plurality of colors comprise red, green, and blue.

11. The computer readable program of claim 9, further comprising instructions to display an image of the biological sample.

12. The computer readable program of claim 9, further comprising instructions to cause the computer to:
measure a color channel value in a plurality of pixels from a plurality of standard samples, wherein each standard comprises a single color of interest;
define a vector for each of the plurality of control samples, wherein each vector comprises an average of each color channel value present in the standard;
define a matrix comprising each of the averages for each of the color channels;
define a conversion matrix comprising the inverse of the matrix based upon the control measurements;
measure color channel values in an image of the biological sample comprising the IHC stained polypeptide and a CISH stained polynucleotide, each of the pixels comprising a plurality of color channels; and
calculate the amount a polypeptide or polynucleotide by converting the channel values in the experimental sample using the conversion matrix.

13. The computer readable program of claim 9, further comprising rendering a digital display of the experimental sample.

14. A machine vision system for automated analysis of a biological sample on a slide comprising:
a computer comprising:
a system processor;
a computer program on computer readable medium, the computer program comprising an image algorithm comprising instructions to cause the computer to:
measure a color channel value in a plurality of pixels from a plurality of control samples comprising a single color of interest;
define a vector for each of the plurality of control samples, wherein each vector comprises an average of each color channel value present in the control;
define a matrix comprising each of the averages for each of the color channels;
define a conversion matrix comprising the inverse of the matrix based upon the control measurements;
measure color channel values in an image of an experimental sample comprising a plurality of colors of interest, each of the pixels comprising a plurality of color channels;
determine an amount of an IHC stained polypeptide in the sample and an amount of a CISH stained polynucleotide by calculating the amount of a color in the experimental sample by converting the channel values in the experimental sample using the conversion matrix; and
outputting an indication of the amounts of polypeptide and polynucleotide.
a monitor in operable communication with the computer; and
an input device in communication with the computer;
an optical system in operable communication with the computer, comprising:
a movable stage;
an automated loading and unloading member for loading and unloading of a slide;
an identification member;
an optical sensing array in optical communication with the stage configured to acquire an image at a location on a slide and in electrical communication with the processor;
a storage member for storing the location of a candidate object or area of interest; and
a storage device for storing each image.
